(19) United States
(12) Patent Application Publication
(10) Pub. No.: US 2008/0222985 A1
(43) Pub. Date: Sep. 18, 2008

(54) Composite for protection against wind and wind blown debris

(76) Inventors: Jeffrey Alan Hanks, Midlothian, VA (US); Helga R. Kuhlmann, Wilmington, DE (US); David White Prior, Midlothian, VA (US); Zakirhushain G. Dugla, Richmond, VA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/151,696

(22) Filed: May 8, 2008

Related U.S. Application Data
(63) Continuation of application No. 11/313,560, filed on Dec. 21, 2005.

(51) Int. Cl. E04B 5/00; B32B 5/02; B32B 3/12

(52) U.S. Cl. 52/411; 442/134; 428/116

(57) ABSTRACT

A composite suitable as an integral portion of a building affording protection from wind blown debris such as from a tornado comprises in order a layer of structural sheathing material such as plywood, a layer of adhesive, a lightweight material, a layer of adhesive, a layer of fabric of high strength fibers bonded resin, a layer of adhesive, and a layer of a structural sheathing material.

### RELATED APPLICATION

The present patent application is a continuation of copending prior application Ser. No. 11/313,560 filled Dec. 21, 2005.

### TECHNICAL FIELD

The invention relates to the use of a high strength composite sheathing to resist penetration by wind and wind-borne debris such as that generated by severe storm events, particularly tornadoes.

### BACKGROUND OF THE INVENTION

Storm shelters and cellars are necessary to provide a safe haven for protection against severe storm events in regions prone to tornado or hurricane activity. These shelters have been typically constructed of poured concrete, steel reinforced masonry, or heavy weight sheet metal. Details of adequate designs for storm shelters and cellars are detailed in publications from the Federal Emergency Management Agency (FEMA) such as Taking Shelter from the Storm—Publication 320 and Design and Construction Guidance for Community Shelters—Publication 361. The current designs rely on the use of common heavyweight construction materials such as concrete and steel to provide the resistance to wind-borne debris generated in the storm event.

The current designs are not easily incorporated into current building practices, and result in significant weight increases in the wall structure. The wood framing approaches described in FEMA Publication 320 require the in-filling of the wall section with solid masonry or continuous sheathing with 14 gauge steel plate. Doors for these shelters required the reinforcement with a minimum 14-gauge sheet metal to provide the needed penetration resistance. These approaches are cumbersome, difficult to install and difficult to field work to size. In regards to doors, the current solutions result in heavyweight doors that introduce safety issues and poor aesthetics.

A report dated May 31, 2000 by Clemson University submitted to the Federal Emergency Management Agency entitled “Enhanced Protection for Severe Wind Storms” describes several additional approaches for the reinforcement of shelter walls against wind-borne debris. Concepts included 4 walls (numbers 9,10,11 & 17) that made use of Kevlar® cloth. FIG. 12 on page 36 shows that these flexible cloth concepts provided no more than 44% of the impact resistance required to meet the “National Performance Criteria for Tornado Shelters”. No concept proposed in this study provided more than 60% of the requirements.

U.S. 2003-0079430 A1 published May 1, 2003 discloses a fiber reinforced composite sheathing employing a fabric of high strength fibers bonded with resin in combination with structural sheathing. The composite has an ability to withstand a 15-pound projectile at a speed of 161 kilometers (100 miles) per hour.

U.S. patent application Ser. No. 10/308,492 sets forth the composite of U.S. 2003-0079430 A1 in combination with a layer of material having a density not greater than 0.25 grams per cubic centimeter.

A substantial need exists for a method of forming a composite using lightweight field friendly materials to provide protection from wind and wind-borne debris such as that generated in tornadoes and hurricanes. However, wind speeds generated by tornadoes can exceed 200 miles per hour which is greatly in excess of wind speeds generated by hurricanes. Therefore, a particular need exists for the lightweight field workable sheathing to withstand both wind and wind-borne debris generated by the higher tornado wind speeds.

### SUMMARY OF THE INVENTION

The present invention is directed to:
a composite comprising in order:
(a) a layer of structural sheathing,
(b) a layer of adhesive,
(c) a layer of material having a density not greater than 0.25 grams per cubic centimeter,
(d) a layer of adhesive,
(e) a layer of a fabric containing high strength fibers bonded with a resin,
(f) a layer of adhesive,
(g) a layer of structural sheathing.
   wherein the fabric layer will deflect in a range from 5.0 to 17.5 centimeters when impacted by a 6.8-kilogram (15 pound) projectile at a speed of 161 kilometers (100 miles) per hour in accordance with ASTM test procedure E1886-97.

The adhesively bonded composite can be designed to meet both the wind pressure and windborne debris requirements by selection of the core and structural sheathing properties, so as to meet the specifications listed above, and in accordance with available structural design formula for foam filled structures. These formulas can be found in publications such as “Design of Foam-Filled Structures,” by John Hartsock, and “Design and Fabrication of Plywood Sandwich Panels” published by the American Plywood Association.

The composite is particularly adapted for construction of storm shelters and residences located in areas of the world which are subjected to wind-blown debris not only by hurricanes but also from the substantially higher wind speeds of tornadoes.

### BRIEF DESCRIPTION OF DRAWINGS

FIG. 1 represents a load deflection curve for an 86-inch long panel of Examples 1, 2 and 3 in accordance with ASTM E72 Traverse Load Test.

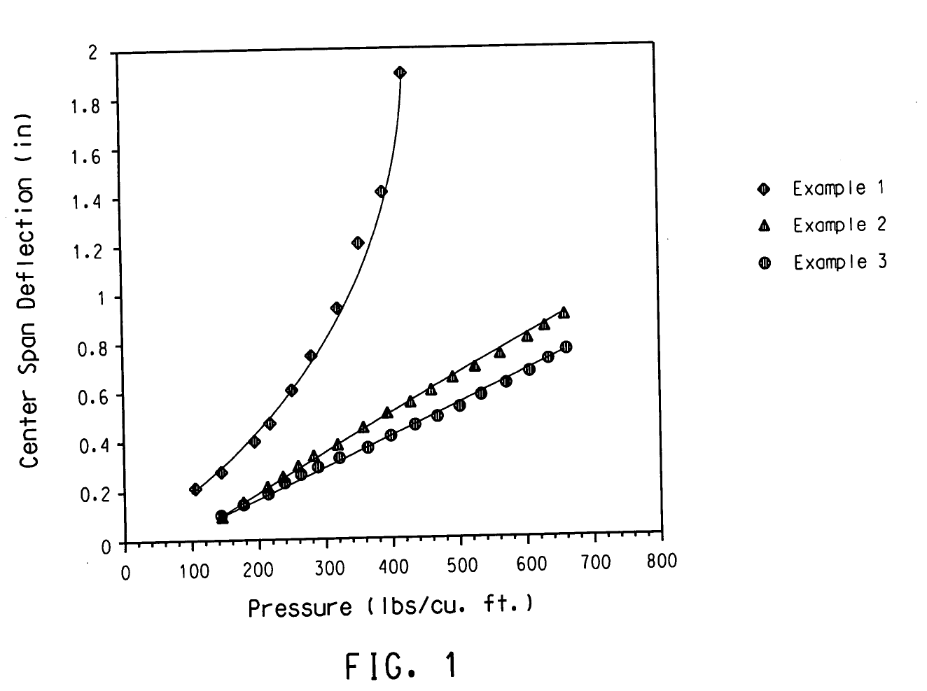

### DETAILED DESCRIPTION OF THE INVENTION

The present invention is an improvement in formation of a composite employing a high strength bonded fabric layer as defined in the Summary of the Invention. Although the high strength bonding fabric layer in combination with structural sheathing is highly effective in providing protection against wind blown debris, a need is present for protection against the force of only wind in a free standing composite.

The present invention overcomes a need for a robust and/or complicated framing structure to hold a composite in place. Due to rigidity yet as the same time flexibility in the composite, protection is obtained from the effects of wind per se and wind blown debris.

Rigidity in the composite is necessary to obtain protection opposite air pressure generated due to wind speed. Flexibility is present in the composite opposite wind blown debris wherein debris can puncture an outer sheathing before striking a high strength bonded fabric which will deflect in a range of 5.0 to 17.5 centimeters when impacted by a 6.8 kilogram (15 pound) projectile at a speed of 161 kilometers (100 miles) per hour in accordance with ASTM test procedure E1886-97.

Therefore, a necessary component for protection against wind-blown debris such as generated by tornadoes with wind speeds in excess of 200 miles per hour is a fabric containing high strength fiber. The fabric may be a woven or non-woven although a woven fabric is preferred. High strength fibers are well known and as employed herein means fibers having a tenacity of at least 10 grams per dtex and a tensile modulus of at least 150 grams per dtex. Yarns can be made from fibers such as aramids, polyolefins, polybenzoxazole, polybenzothiazole, glass and the like, and may be made from mixtures of such yarns.

The fabric may include up to 100 percent aramid fiber. By “aramid” is meant a polyamide wherein at least 85% of the amide (—CO-NH—) linkages are attached directly to two aromatic rings. Examples of aramid fibers are described in Man-Made Fibers-Science and Technology₁ Volume 2, Section titled Fiber-Forming Aromatic Polyamides, page 297, W. Black et al., Interscience Publishers, 1968. Aramid fibers are, also, disclosed in U.S. Pat. Nos. 4,172,938; 3,869,429; 3,819,587; 3,673,143; 3,354,127; and 3,094,511.

Para-aramids are common polymers in aramid yarn and poly(p-phenylene terephthalamide) (PPD-T) is a common para-aramid. By PPD-T is meant the homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloylchloride or chloro- or dichloroterephthaloyl chloride or 3,4-diaminodiphenylether.

By “polyolefin” is meant polyethylene or polypropylene. By polyethylene is meant a predominantly linear polyethylene material of preferably more than one million molecular weight that may contain minor amounts of chain branching or co-monomers not exceeding 5 modifying units per 100 main chain carbon atoms, and that may also contain admixed therewith not more than about 50 weight percent of one or more polymeric additives such as alkene-1-polymers, in particular low density polyethylene, propylene, and the like, or low molecular weight additives such as anti-oxidants, lubricants, ultra-violet screening agents, colorants and the like which are commonly incorporated. Such is commonly known as extended chain polyethylene (ECPE). Similarly, polypropylene is a predominantly linear polypropylene material of preferably more than one million molecular weight. High molecular weight linear polyolefin fibers are commercially available.

Polybenzoxazole and polybenzothiazole are preferably made up of polymers of the following structures:

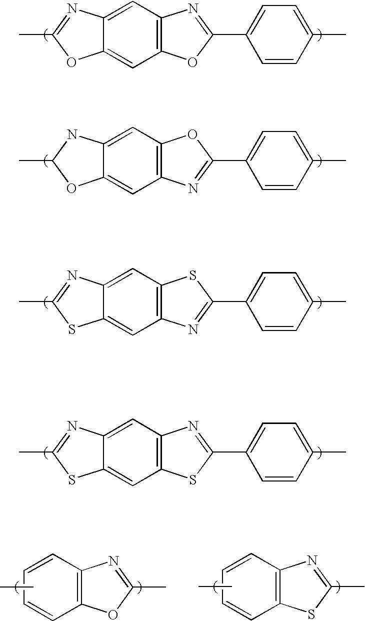

While the aromatic group shown joined to the nitrogen atoms may be heterocyclic, they are preferably carbocyclic; and while they may be fused or unfused polycyclic systems, they are preferably single six-membered rings. While the group shown in the main chain of the bis-azoles is the preferred para-phenylene group, that group may be replaced by any divalent organic group which does not interfere with preparation of the polymer, or no group at all. For example, that group may be aliphatic up to twelve carbon atoms, tolylene, biphenylen, bis-phenylene either, and the like.

A further requirement in the present invention is the use of a resin to bind individual fibers of the high strength fibers in the employed fabric. The resin may be selected from a wide variety of components such as polyethylene, ionomers, polypropylene, nylon, polyester, vinyl ester, epoxy and phenolics and thermoplastic elastomers.

The resin may be applied to the fabric containing high strength fibers by coating or impregnation, such as under pressure.

Accordingly, the high strength fabric/resin combination must have an ability for deflection within the layered composite when tested in accordance with National Performance Criteria for Tornado Shelters, First Addition, FEMA, May 28, 1999 using ASTM Test Method E1886-97, entitled “Standard Test Method for Performance of Exterior Window, Certain Walls, Doors and Storm Shutters Impacted by Missile(s) and Exposed to Cyclic Pressure Differentials.” Highlights of the test include mounting the test specimen, impacting the specimen with a 6.8 kilogram (15 pound) 2×4 missile propelled at a speed of 161 kilometers (100 miles) per hour and observing and measuring the test results. The ASTM test procedure E1886-97 is specific to the various requirements such as the use of 2×4 lumber missile, missile propulsion device, speed measuring system and use of a high-speed video or photographic camera. It is understood, herein, that the test procedure for purposes of the present disclosure, involves attaching any test specimen to a suitable support frame, in such a way that is representative of an actual wall installation. Such specimen is then impacted on the plywood face at or near the center of the panel. The 2×4 lumber missile should be marked with suitable indexing marks to allow the tracking of the depth of penetration of the projectile. The photographic or video camera should be positioned to monitor the depth of penetration of the projectile and such camera should have a minimum frame rate of 1000 frames per second.

In accordance with the described test procedure, the fabric containing high strength fibers bonded with a resin will deflect within a range from 5.0 to 17.5 cm. More preferably, the deflection will be in a range from 8.0 to 16.0 cm and most preferably 10.0 to 15.0 cm. It is understood the deflection of the fabric would be typically performed in a separate test procedure on a sheathing (such as plywood)/fabric combination which is not bonded to one another. In such case the sheathing/fabric separate from one another in the test procedure.

The degree of deflection may be determined by its final use in a building structure. Illustratively, a maximum stated deflection of the fabric/resin combination may be undesirable in a residence due to the proximity of an occupant adjacent a wall containing the cloth/resin combination. However, a minimum deflection within the above range can require an added thickness of the fabric resulting in a high cost of construction. As employed herein, fabric is inclusive of more than one layer of a cloth. As employed herein deflection means the maximum measured distance of separation of the high strength fabric/resin combination from the structural sheathing (i.e. the separation due to the impact). As previously stated the test procedure is undertaken when the high strength fabric/resin combination is not bonded to the sheathing. It is understood that the measurement must be undertaken in conjunction with high-speed photography. For purposes of illustration for deflection measurement, if during the test procedure with the projectile, there may be some bowing of the structural sheathing. The measurement for deflection is the distance, i.e., the separation, of the high strength fabric/resin combination from the bowed portion of the sheathing. It can be determined from review of the photographic or video record collected during previously described testing, determining the maximum depth of penetration during the event, and subtracting the thickness of the structural sheathing.

In the present invention the combination of the fabric containing the high strength fibers/resin is for employment with a wood based or other structural sheathing material, since an additional purpose of the combination is the structural reinforcement of a wall or door. The term “structural sheathing” is inclusive of any material which provides structural building support. The preferred material is wood, particularly plywood, due to extensive use in the building industry. However other materials are known for structural sheathing serving as building support: a typical example is fiberboard reinforced with cement. The fabric/resin combination is generally flexible and will be employed with the sheathing which for purposes of illustration may be at least 0.65 cm (one quarter inch) and preferably for purposes of support, at least 1.27 cm (one half inch). The type of structural sheathing is not critical to the success of the present invention. The sheathing may be solid such as from hard or soft woods or may be in the form of a composite such as plywood or a non-wood sheathing such as cementous fiberboard plastic composite and thin gauge metal. As a practical matter, it is believed that most uses of the present invention will be with plywood since it is a common material used in wall structures. There is no maximum thickness to the structural sheathing which in a building structure will be or face an outer wall with the combination of fabric/resin facing the inner portion of the building, i.e., for example a room where inhabitants are to be protected.

In accordance with the present invention, structural sheathing will be present on opposite faces of the composite holding the remaining components in a sandwich construction. It is understood that the layers of structural sheathing need not be identified.

Therefore, in construction of a protective shelter or one or more rooms in a residence, it is intended that the structural sheathing face the direction of any wind-borne debris such that the debris strikes the sheathing with penetration before contact and containment with deflection of the combination of cloth/resin. It is understood that the invention is particularly advantageous since conventional building construction and techniques with structural sheathing may be employed.

In the present invention an improvement is present for wind as well as impact or striking resistance through use of a the following composite construction present in order:
structural sheathing
adhesive
bonded higher strength fiber
adhesive
lightweight material adhesive
adhesive
a structural sheathing

The lightweight material will have a density of not greater than 0.25 grams per cubic centimeter, preferably, not greater than 0.10 grams per cubic centimeter, and more preferably, not greater than 0.05 grams per cubic centimeter.

The lightweight material may be flexible or rigid. However, it is within the scope of the present invention for rigidity to be provided by support or reinforcement of the lightweight material. Therefore, the lightweight material may not be self-supporting but the overall lightweight material layer will have flexibility or rigid through use of a support or reinforcement to provide this property. Therefore, in a preferred mode, the layer containing the lightweight material is self-supporting, i.e., it will not collapse. In this preferred mode, sufficient shear modulus and shear strength is needed in the lightweight material to provide for the wind pressure resistance. The needed shear stiffness and strength can be calculated from common design formula using the previous detailed references, depending on the make-up of the structural skins, thickness of the lightweight core, and length of the composite panel being produced. Illustratively, the lightweight materials include, for example, polystyrene and polyurethane, which can be present as foams or honeycomb structures made, for example, from kraft paper, aramid paper, aluminum sheeting and plastic. For a nominal 4 foot wide by 8-foot long composite panel, having a core thickness of 4 inches, the lightweight material will typically need a shear modulus greater than 300-pounds/square inch and a shear strength greater than 25-pounds/square inch to provide resistance to 250 mile per hour winds. These properties are typically present in expanded polystyrene foam with a density greater than 1.0 pound/cubic foot. The lightweight material can as well be a foam structure reinforced with light-gauge steel members or wires as described in U.S. Pat. No. 4,241,555. However, such use is not necessary due to use of an adhesive on opposite sides of the lightweight material.

The thickness of the lightweight material layer is not critical with an example in the range of 5.0 to 20.0 centimeters. When thinner lightweight materials are used, the shear strength and shear modulus must be higher to provide for the wind resistance. When thicker lightweight materials are used, the shear modulus and shear strength can be lower.

In addition to use of a bonded high strength fabric, three layers of adhesive are employed, namely (a) between structural sheathing, and material having a density not greater than 0.25 grams per cubic centimeter), (b) between the material having a density not greater than 0.25 grams per cubic centimeter and fabric containing high strength fibers bonded with a resin and, (c) fabric containing high strength fibers bonded with a resin and structural sheathing. The types of adhesive are not considered critical and can be the same resins as described for bonding the high strength fibers, but adhesives must provide sufficient bond strength to make the composite act as a single unit resisting bending under the pressure created by the impinging wind.

To further illustrate the present invention, the following examples are provided.

### EXAMPLE 1

A 48-in by 86-in laminated wall panel was produced in a pneumatic platen press by stacking in sequence the following materials:
1. One sheet of plywood, 23/32-inch thick, APA rated sheathing.
2. One layer of ISOGRIP® 3030 Urethane Adhesive at 20 gms/sq-ft.
3. One layer of 4-inch thick, expanded polystyrene foam core, with a density of 1.0 lb/cu-ft.
4. One layer of ISOGRIP® 3030 Urethane Adhesive at 20 gms/sq-ft.
5. Three ply's of Kevlar® Style 745 fabric (13 oz/sq-yd weight) that had been thermally bonded together with a polyolefin bonding resin.
6. One layer of ISOGRIP® 3030 Urethane Adhesive at 20 gms/sq-ft
7. One sheet of plywood, 15/32-inch thick, APA rated sheathing.

The glue was applied as detailed above with an industrial glue roll coater. The assembled panel was placed in the pneumatic press and held under pressure of 7-lbs/sq-in for one hour and the glues allowed to fully cure over 24 hours, before being sent for testing.

The panel was pressure tested in a vacuum rig in accordance with ASTM test method E72. The panel failed at a pressure of 425 lbs/sq-ft and showed excessive deformation and a non-linear load deflection cure. The load deflection curve is shown in the Figure. The ultimate failure load of this panel would not provide the margin of safety needed for use in the highly loaded sections of wind shelters, and would not provide the needed rigidity in the walls to meet typical building standards for load bearing walls.

An additional 48-in-by-48-in test panel was produced as described above to access the ability of the wall to resist the penetration by windborne debris. The panel was impact tested, with a 15-pound lumber projectile at a speed of 161 kilometers (100 miles) per hour in accordance with ASTM test procedure E1886-87. The projectile did not penetrate the wall.

### EXAMPLE 2

A 48-in by 86-in laminated wall panel was produced in a pneumatic platen press as described in Example 1 with 4-inch thick expanded polystyrene foam core with the density increased to 2.5 lb/cu-ft.

The panel was pressure tested in a vacuum rig in accordance with ASTM test method E72. The panel failed at a pressure of 673 lbs/sq-ft and showed low deformation and a linear load deflection cure. The load deflection curve is shown in the Figure. The ultimate failure load of this panel would provide the margin of safety needed for use in the highly loaded sections of wind shelters, and would provide the needed rigidity in the walls to meet typical building standards for load bearing walls.

An additional 48-in-by-48-in test panel was produced as described above to access the ability of the wall to resist the penetration by windborne debris. The panel was impact tested, with a 15-pound lumber projectile at a speed of 161 kilometers (100 miles) per hour in accordance with ASTM test procedure E1886-87. The projectile did not penetrate the wall.

An additional 48-in by 86-in laminated wall panel was produced in a pneumatic plated press as described above. This panel was impact tested in a shelter room assembly connected together with flexible joints as detailed in US patent application KB 4640 US NA. Impact testing was done with a 15-pound lumber projectile at a speed of 161 kilometers (100 miles) per hour in accordance with ASTM test procedure E1886-87. The projectile did not penetrate the wall panel.

### EXAMPLE 3

A 48-in by 86-in laminated wall panel was produced in a pneumatic platen press as described in Example 1 with 4-inch thick expanded polystyrene foam core with the density increased to 3.0 lb/cu-ft.

The panel was pressure tested in a vacuum rig in accordance with ASTM test method E72. The panel failed at a pressure of 673 lbs/sq-ft and showed low deformation and a linear load deflection cure. The load deflection curve is shown in the Figure. The ultimate failure load of this panel would provide the margin of safety needed for use in the highly loaded sections of wind shelters, and would provide the needed rigidity in the walls to meet typical building standards for load bearing walls.

An additional 48-in-by-48-in test panel was produced as described above to access the ability of the wall to resist the penetration by windborne debris. The panel was impact tested, with a 15-pound lumber projectile at a speed of 161 kilometers (100 miles) per hour in accordance with ASTM test procedure E1886-87. The projectile did not penetrate the wall.

What is claimed is:

1. A composite comprising in order:
(a) a layer of structural sheathing,
(b) a layer of adhesive,
(c) a layer of material having a density not greater than 0.25 grams per cubic centimeter,
(d) a layer of adhesive,
(e) a layer of a fabric containing high strength fibers bonded with a resin,
(f) a layer of adhesive,
(g) a layer of structural sheathing,
wherein the fabric layer deflects in a range from 5.0 to 17.5 centimeters when impacted by a 6.8-kilogram (15 pound) projectile at a speed of 161 kilometers (100 miles) per hour in accordance with ASTM test procedure E1886-97;
wherein the layer of material having a density not greater than 0.25 grams per cubic has a thickness in a range from 5.0 to 20.0 centimeters; and
wherein the high strength fibers have a tenacity of at least 10 grams per dtex and a tensile modulus of at least 150 grams per dtex.

2. The composite of claim 1 wherein the deflection is in a range from 8.0 to 16.0 centimeters.

3. The composite of claim 1 wherein the high strength fibers are selected from the group consisting of aramid fibers, glass fibers, polyethylene fibers, polyvinyl alcohol fibers, polyarylate fibers, polybenzazole fibers, or carbon fibers.

4. The composite of claim 1 wherein the high strength fibers comprise an aramid.

5. The composite of claim 1 wherein the high strength fibers are glass.

6. The composite of claim 1 wherein the structural sheathing comprises plywood.

7. The composite of claim 1 wherein layer (c) has a density not greater than 0.10 grams per cubic centimeter.

8. The composite of claim 1 wherein layer (c) is a foam.

9. The composite of claim 1 wherein layer (c) has a honeycomb or honeycomb-like structure.

10. A building structure having an integral portion of the structure comprising:
(a) a layer of structural sheathing,
(b) a layer of adhesive,
(c) a layer of material having a density not greater than 0.25 grams per cubic centimeter,
(d) a layer of adhesive,
(e) a layer of a fabric containing high strength fibers bonded with a resin,
(f) a layer of adhesive,
wherein the fabric layer deflects in a range from 5.0 to 17.5 centimeters when impacted by a 6.8-kilogram (15 pound) projectile at a speed of 161 kilometers (100 miles) per hour in accordance with ASTM test procedure E1886-97;
wherein the layer of material having a density not greater than 0.25 grams per cubic has a thickness in a range from 5.0 to 20.0 centimeters; and
wherein the high strength fibers have a tenacity of at least 10 grams per dtex and a tensile modulus of at least 150 grams per dtex.
